(19) United States
(12) Patent Application Publication
(10) Pub. No.: US 2015/0009103 A1
(43) Pub. Date: Jan. 8, 2015

(54) Wearable Display, Computer-Readable Medium Storing Program and Method for Receiving Gesture Input

(71) Applicant: Brother Kogyo Kabushiki Kaisha, Nagoya-shi (JP)

(72) Inventors: Kunihiro Ito, Ama-shi (JP); Hiroshi Inoue, Nisshin-shi (JP)

(21) Appl. No.: 14/495,448

(22) Filed: Sep. 24, 2014

Related U.S. Application Data
(63) Continuation-in-part of application No. PCT/JP2013/058959, filed on Mar. 27, 2013.

(30) Foreign Application Priority Data
Mar. 29, 2012 (JP) 2012-078044

(51) Int. Cl. G02B 27/01; G06F 3/01

(52) U.S. Cl. CPC G02B 27/017; G06F 3/017; G02B 2027/0178
USPC 345/8

(57) ABSTRACT

A wearable display control device may perform extracting, storing, obtaining, determining and controlling. The extracting may extract a characteristic quantity indicating a characteristic of a particular part. The storing may store a first characteristic quantity in a memory. The obtaining may obtain gesture data of the particular part from second captured data captured after the first characteristic quantity is stored in the memory. The gesture data may indicate a gesture of the particular part. The determining may determine whether the first characteristic quantity corresponds to a second characteristic quantity extracted from the second captured data. The controlling may control a specific process that controls a display device in response to determining that the first characteristic quantity corresponds to the second characteristic quantity and may not control the specific process in response to determining that the first characteristic quantity does not correspond to the second characteristic quantity.

### CROSS-REFERENCE TO RELATED APPLICATION

The present application is a continuation-in-part of International Application No. PCT/JP2013/058959, filed on Mar. 27, 2013, which claims the benefit of Japanese Patent Application No. 2012-078044, filed on Mar. 29, 2012, the disclosure of which is incorporated herein by reference.

### FIELD

Aspects described herein relate to image display systems and more specifically to a display controller, wearable displays and computer-readable media for receiving gesture input.

### BACKGROUND

A technique related to a head mount display which is mounted on a user's head and displays images to the user has been proposed. For example, a head mount display which receives gesture input is known. When a controller of a head mount display detects that a part of an operator's body (for example, a hand and a finger) has made a predetermined motion, the controller starts a process corresponding to a virtual icon in a space. With the gesture input, an operation instruction by the operator may be provided easily and a complicated operation instruction may be provided in a simple way.

### BRIEF SUMMARY

A wearable display (e.g., a head mount display) may be mounted on an object (e.g., a user's head). Even when the user wears the head mount display and is viewing images displayed on the head mount display, the user may move without inconvenience. For example, the user may even move to a location where persons other than the user exist. For example, the head mount display may capture an image of a particular portion, such as the user's hand by capturing an image of the front visual field of the user. The head mount display may execute a process corresponding to a motion of the particular portion in accordance with image data. Desirably, the process corresponding to the motion of the particular portion may be performed in association with the user who wears the head mount display. If an image of a particular portion of a person, located in the direction in which the user's face is oriented, other than the user who wears the head mount display is captured, a process in accordance with the motion of the particular portion of the person other than the user might be executed. The process in accordance with the motion of the particular portion of the person other than the user may not be a necessary process that may not be intended by the user and, therefore, such a process may decrease operability of gesture input.

The present disclosure may provide a wearable display control device, a computer program and a method configured to improve operability of gesture input.

According to an aspect of the present disclosure, a wearable display control device may comprise one or more processors and a memory. The memory stores computer-readable instructions therein, the computer-readable instructions, when executed by the one or more processors, instructing the processor to perform processes. The processes may comprise an extracting operation, a storing operation, an obtaining operation, a determining operation and a controlling operation. The extracting operation may extract a characteristic quantity from captured data obtained from a camera. The characteristic quantity may indicate a characteristic of a particular part. The particular part may be a reference of gesture input. The storing operation may store a first characteristic quantity in a memory. The first characteristic quantity may be the characteristic quantity extracted by the extracting operation from first captured data. The obtaining operation may obtain gesture data of the particular part from second captured data. The second captured data may be captured by the camera after the first characteristic quantity is stored in the memory by the storing operation. The gesture data may indicate a gesture of the particular part. The determining operation may determine whether the first characteristic quantity stored in the memory corresponds to a second characteristic quantity. The second characteristic quantity may be extracted from the second captured data by the extracting operation. The controlling operation may control a specific process that controls a display device in response to determining that the first characteristic quantity corresponds to the second characteristic quantity and may not control the specific process in response to determining that the first characteristic quantity does not correspond to the second characteristic quantity. The specific process may be stored in a memory in association with the gesture data.

According to another aspect of the present disclosure, a non-transitory computer-readable medium may store computer readable instructions. The instructions, when executed by a processor of a wearable display control device, may perform processes. The processes may comprise an extracting operation, a storing operation, an obtaining operation, a determining operation and a controlling operation. The extracting operation may extract a characteristic quantity from captured data obtained from a camera. The characteristic quantity may indicate a characteristic of a particular part. The particular part may be a reference of gesture input. The storing operation may store a first characteristic quantity in a memory. The first characteristic quantity may be the characteristic quantity extracted by the extracting operation from first captured data. The obtaining operation may obtain gesture data of the particular part from second captured data. The second captured data may be captured by the camera after the first characteristic quantity is stored in the memory by the storing operation. The gesture data may indicate a gesture of the particular part. The determining operation may determine whether the first characteristic quantity stored in the memory corresponds to a second characteristic quantity. The second characteristic quantity may be extracted from the second captured data by the extracting operation. The controlling operation may control a specific process that controls a display device in response to determining that the first characteristic quantity corresponds to the second characteristic quantity and may not control the specific process in response to determining that the first characteristic quantity does not correspond to the second characteristic quantity. The specific process may be stored in a memory in association with the gesture data.

According to yet another aspect of the present disclosure, a method may comprise an extracting step, an obtaining step, a determining step and a controlling step. The extracting step may extract a characteristic quantity from captured data obtained from a camera. The characteristic quantity may indicate a characteristic of a particular part. The particular part may be a reference of gesture input. The obtaining step may obtain gesture data of the particular part from captured data captured by the camera. The gesture data may indicate a gesture of the particular part. The determining step may determine whether the first characteristic quantity stored in the memory corresponds to a second characteristic quantity. The second characteristic quantity may be extracted from the second captured data by the extracting step. The controlling step may control a specific process that controls a display device in response to determining that the first characteristic quantity corresponds to the second characteristic quantity and may not control the specific process in response to determining that the first characteristic quantity does not correspond to the second characteristic quantity. The specific process may be stored in a memory in association with the gesture data.

### BRIEF DESCRIPTION OF THE DRAWINGS

For a more complete understanding of the disclosure, and the objects, features, and advantages thereof, reference now is made to the following descriptions taken in connection with the accompanying drawing.

FIG. 1 is a diagram illustrating an example of a wearable display according to illustrative aspects.

FIG. 2A is a plan view of a display device according to illustrative aspects;

FIG. 2B is a cross sectional view illustrating the display device taken along the center of an up-down direction illustrated in FIG. 1.

FIG. 3 is a block diagram illustrating an electrical configuration of the head mounted display according to illustrative aspects;

FIG. 4 is a flowchart of a main process according to illustrative aspects;

FIG. 5 is a flowchart of a registration process according to illustrative aspects;

FIG. 6 is a flowchart of a gesture reception process according to illustrative aspects; and

FIG. 7 is a flowchart of a gesture determination process according to illustrative aspects.

### DETAILED DESCRIPTION

Illustrative embodiments for implementing the present disclosure will be described with reference to the drawings. The present disclosure is not limited to those configurations described below and various configurations of the same technical idea will be adopted. For example, the configuration described below may be partially omitted or replaced by other configurations. Other configurations may be added to the described configuration.

### Head Mounted Display

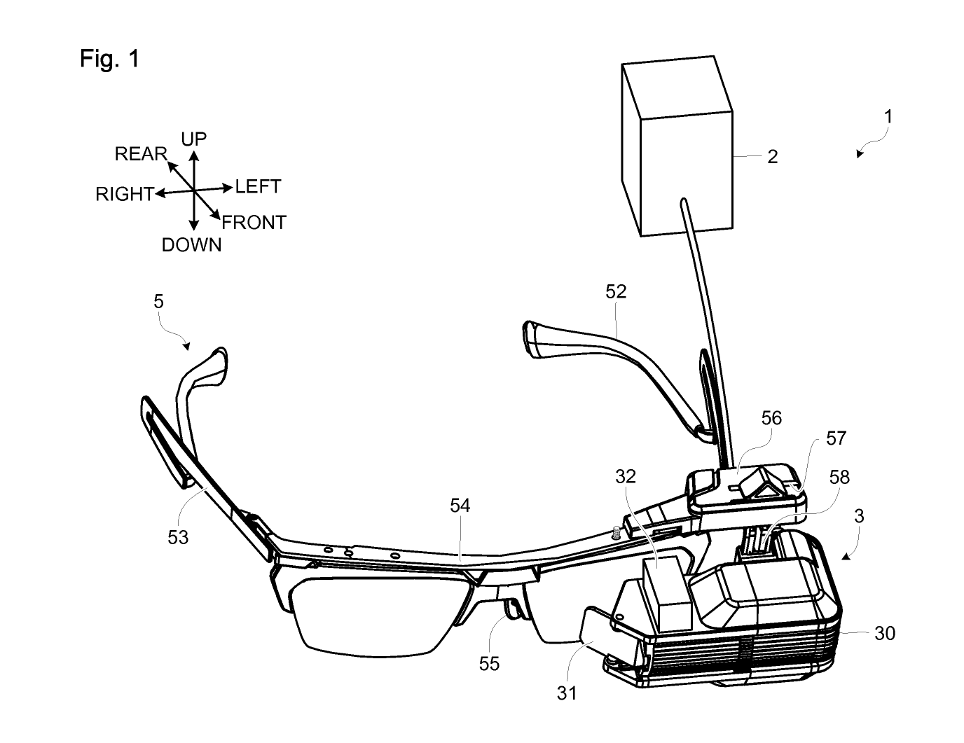

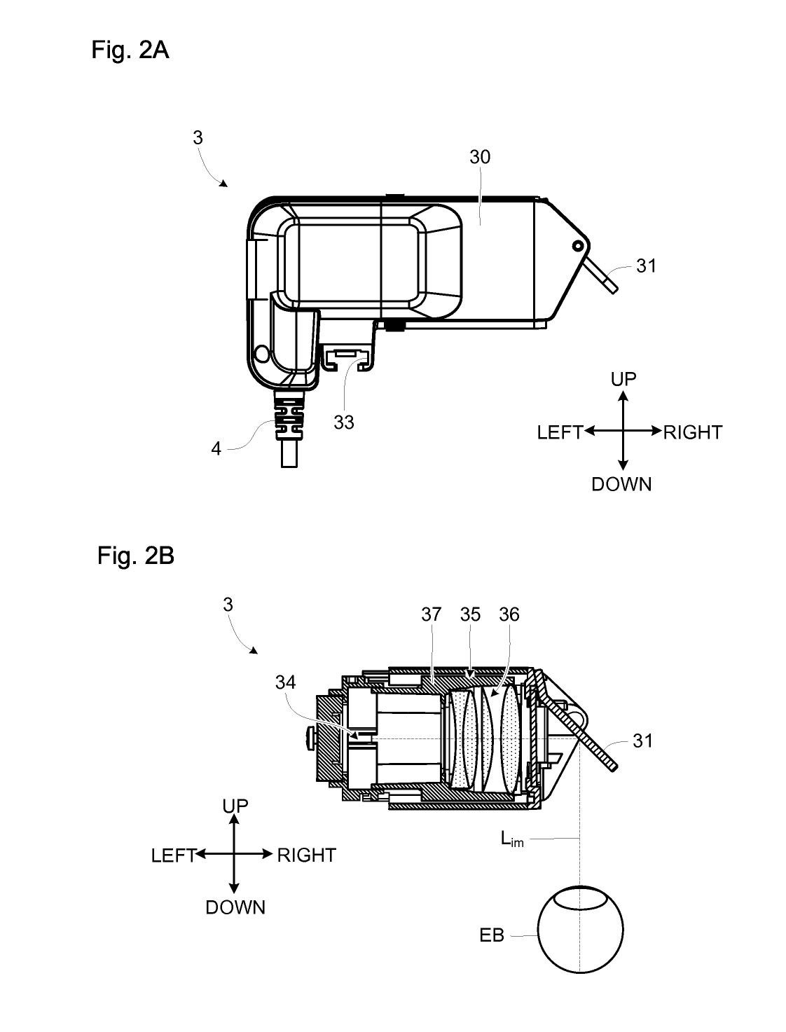

A head mount display (“HMD”) 1 will be described briefly with reference to FIGS. 1 and 2. The HMD 1 may be an example of wearable displays. The front-rear direction and the left-right direction in FIGS. 1 and 2 and the up-down direction in FIG. 1 each corresponds to the front-rear direction, the left-right direction and the up-down direction of a user when a display device 3 is mounted on an object (for example, a user's head) via a spectacle frame 5. To facilitate understanding of the orientation and relationship of the various elements disclosed herein, the front, rear, left, right, up, and down of the HMD 1 may be determined with reference to axes of the three-dimensional Cartesian coordinate system included in each of the relevant drawings.

The HMD 1 may comprise a system box 2 and a display device 3. The system box 2 and the display device 3 may be connected to each other via, for example, a transmission cable 4. The system box 2 may control the display device 3. For example, the system box 2 may transmit image signals to the display device 3. The system box 2 may supply the display device 3 with power.

The display device 3 may be detachably attached to the spectacle frame 5. In other words, the spectacle frame 5 may support the display device detachably. The spectacle frame 5 may be an example of an attaching portion with which the display device 3 may be mounted on an object (for example, the user's head). The display device 3 may be mounted on the head by any other attaching portions than the spectacle frame 5 (for example, a head strap and a helmet). The display device 3 may comprise a housing 30. The housing 30 may be a resin-made, square cylindrical member. The housing 30 may be formed in an L shape in plan view. A deflection member such as a half mirror 31 may be provided at a right end of the housing 30. A camera 32 may be provided in at least one of the display device 3 and the spectacle frame 5. For example, the camera 32 may be provided on an upper surface of the housing 30. The camera 32 may be configured to capture an image of ambient scenery of the HMD 1. The camera 32 may comprise two-dimensional imaging devices, such as CCD and CMOS, an optical system which may focus an ambient image on the two-dimensional imaging devices, and a control circuit which may control the two-dimensional imaging devices. In the present embodiment, the camera 32 may be provided on the upper surface of the housing 30 to capture an ambient image in a direction corresponding to the front of the HMD 1 (for example, a direction which the user's face may be oriented when the HMD 1 is mounted on the user's head). The camera 32 may be inside the housing 30 as long as the camera 32 is able to capture the ambient image.

The spectacle frame 5 may comprise a left frame portion 52, a right frame portion 53, a central frame portion 54 and a support portion 56 as illustrated in FIG. 1. The left frame portion 52 extending in the front-rear direction may be put on the user's left ear. The right frame portion 53 extending in the front-rear direction may be put on the user's right ear. The central frame portion 54 extending in the left-right direction may join a front end portion of the left frame portion 52 and a front end portion of the right frame portion 53, and may be disposed at a user's face portion. A pair of nose pad portions 55 may be provided at the longitudinal direction center of the central frame portion 54. The support portion 56 may be provided on a left end side of the upper surface of the central frame portion 54. The support portion 56 may comprise a downward extending portion 58. The downward extending portion 58 may extend in the up-down direction on the front left side of the user's face. The downward extending portion 58 may slidably engage a groove 57 which may be formed in the support portion 56 and may extend in the left-right direction. The sliding of the downward extending portion 58 in the left-right direction may adjust the position of the display device 3 in the left-right direction.

The display device 3 will be described with reference to FIGS. 2A and 2B. As illustrated in FIG. 2A, a mounting portion 33 may be provided in the housing 30. When the display device 3 may be mounted on the spectacle frame 5, the mounting portion 33 may be provided at a portion to face the spectacle frame 5 of the housing 30. The mounting portion 33 may comprise a U-shaped groove formed along the up-down direction. The downward extending portion 58 provided in the support portion 56 of the spectacle frame 5 may slidably engage the U-shaped groove of the mounting portion 33. The housing 30 attached to the downward extending portion 58 may be slid in the up-down direction so as to adjust the position of the display device 3 in the up-down direction. As illustrated in FIG. 2B, the housing 30 may comprise an image light generator 34 and an ocular optical section 35. Image light Lim output from the image light generator 34 may be condensed by the ocular optical section 35. A part of the condensed image light Lim may be reflected on the half minor 31 and guided to a light receiver (for example, a user's eye EB).

The image light generator 34 may be provided at the left end inside the housing 30. The image light generator 34 may generate the image light Lim in accordance with image signals from the system box 2. The image light generator 34 may be a spatial light modulation element. The spatial light modulation element may be, for example, a liquid crystal display comprising a liquid crystal display element and a light source, or organic electro-luminescence (EL).

Instead of the spatial light modulation element, the image light generator 34 may be a retinal scanning display which may project an image on a retina by carrying out mechanical two-dimensional scanning with light from a light source, such as laser.

The ocular optical section 35 may comprise a lens 36 and a lens holder 37. A left end of the lens holder 37 may be in contact with a right end of the image light generator 34. The lens 36 may be supported at the right side inside the lens holder 37. That is, the lens 36 and the image light generator 34 may be separated, by the lens holder 37, by a distance corresponding to a display distance of a virtual image that is to be displayed to the user. The lens 36 may comprise a plurality of lenses arranged in the left-right direction. In the present embodiment, the lens 36 may comprise a plurality of lenses to attain desired optical properties. However, the lens 36 may be a single lens. The ocular optical section 35 may condense the image light Lim and may guide the condensed light to the half minor 31. Since the user views a virtual image by the display device 3, the image light Lim condensed by the lens 36 may be diffused light or a parallel light. That is, the term “condensing” refers to an effect to an incident light flux by an optical system which has positive power as a whole; thus, an outgoing light flux may not be necessarily convergence light.

The plate-shaped half minor 31 may be connected to the right end of the housing 30. For example, the half minor 31 may be held at a predetermined portion of the housing 30 from above and below at the right end of the housing 30. The half minor 31 may be formed by depositing metal, such as aluminum, on, for example a surface of a plate-shaped transparent member, such as glass and light transmissive resin. Transmittance may be set to be 50%. Since a part of the image light Lim may be reflected on the half mirror 31 and a part of ambient light passes through the half minor 31, the user may view an image (i.e., a virtual image) and ambient scenery in a superimposed manner through the half mirror 31. Light transmissive resin may be, for example, acrylic resin and polyacetal. Transmittance of the half mirror 31 may not be necessarily 50%.

### Electrical Configuration

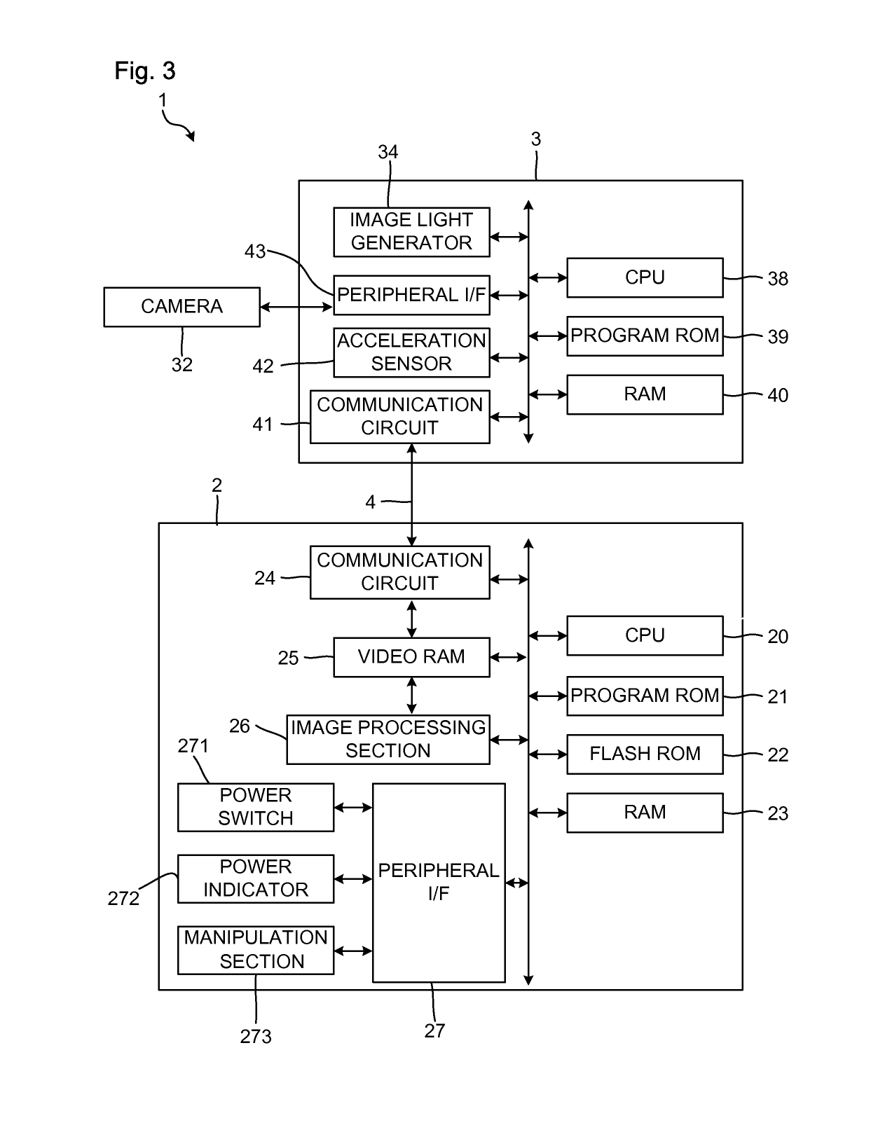

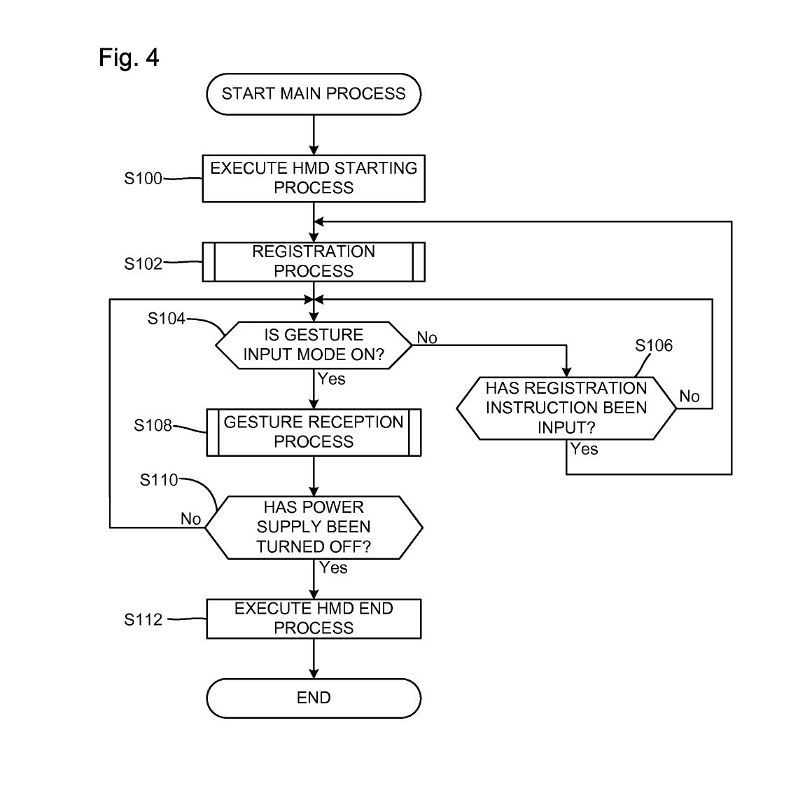

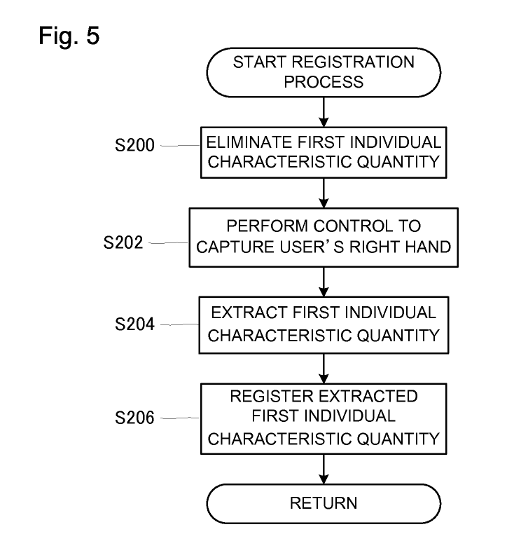

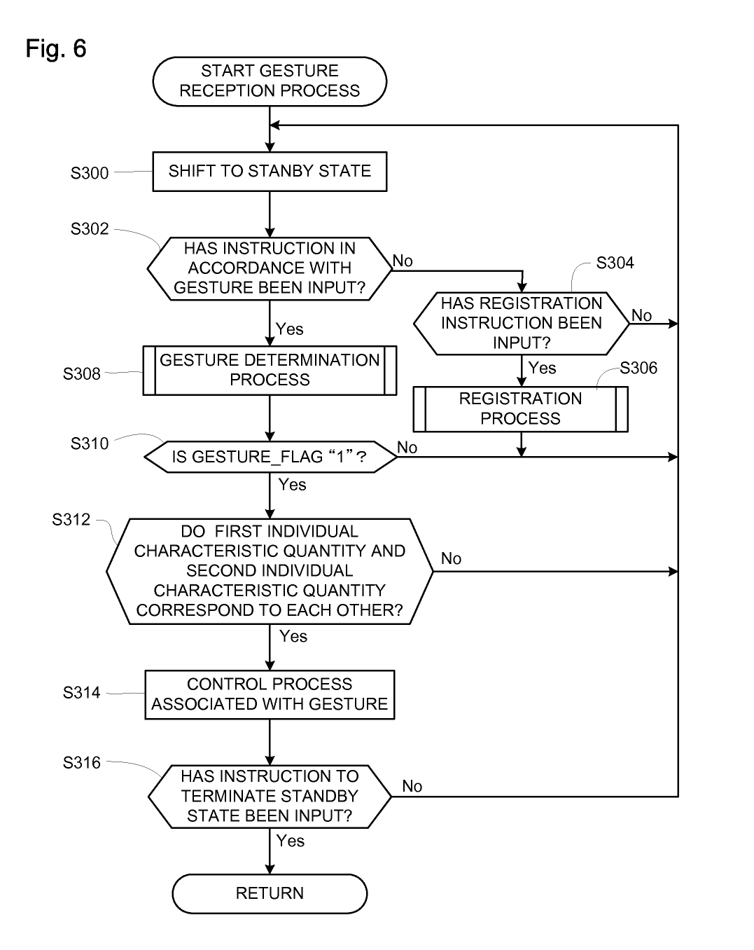

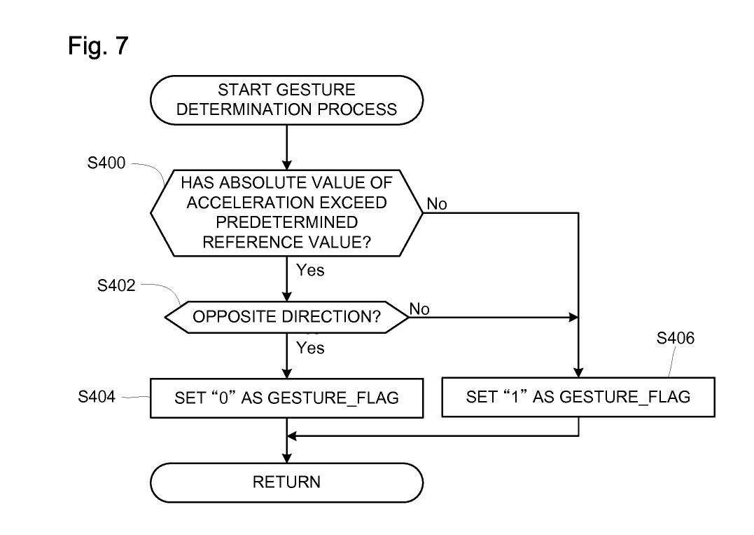

Electrical configurations of the system box 2 and the display device 3 will be described briefly with reference to FIG. 3. The system box 2 may comprise a CPU 20, a program ROM 21, a flash ROM 22, a RAM 23, a communication circuit 24, a video RAM 25, an image processing section 26 and a peripheral I/F 27. The CPU 20 may control various processes executed in the system box 2. Processes controlled by the CPU 20 may be, for example, a main process illustrated in FIG. 4, a registration process illustrated in FIG. 5, a gesture reception process illustrated in FIG. 6, and a gesture determination process illustrated in FIG. 7. The CPU 20 may instruct execution of image processing with respect to the image processing section 26. The program ROM 21 may store computer programs for various processes executed in the system box 2.

The flash ROM 22 may store various types of data. The data stored in the flash ROM 22 may be, for example, image data and a first individual characteristic quantity. The image data may be data corresponding to an image to be displayed on the display device 3. The image data may comprise data corresponding to images for a plurality of pages. In the present embodiment, image data corresponding to image for a plurality of pages will be described as an example. An image of each page corresponding to image data may be displayed on the display device 3. The first individual characteristic quantity may be information indicating a characteristic for identifying a particular part (e.g., a hand). The particular part may is used as a reference of gesture input. The first individual characteristic quantity may be registered in the flash ROM 22 in the registration process described later. The first individual characteristic quantity may be stored or registered in a predetermined storage area in the flash ROM 22. Alternatively, the first individual characteristic quantity may be stored or registered in a predetermined storage area of the program ROM 21 in association with a computer program for the main process. In the present embodiment, an example in which the first individual characteristic quantity may be registered in a predetermined storage area of the flash ROM 22 will be described. In the flash ROM 22, gesture information indicating gesture and process information indicating processes correlated with the gesture information may be stored in association with each other. The gesture may be a motion of a particular portion, such as a hand of the user. The gesture information may be information in which a particular portion and a motion are associated with each other. For example, the gesture information may be information indicating a movement of a right hand which moves from one side to the other side (for example, from the right to the left). The process information may be information indicating, for example, processes to proceed from the image displayed on the display device 3 to the next page or to return to the previous page. The RAM 23 may be a workspace used by the CPU 20 when executing the computer program stored in the program ROM 21.

The communication circuit 24 may control communication between the system box 2 and the display device 3. A transmission cable 4 may be electrically connected to the communication circuit 24. The communication circuit 24 may transmit image signals to the display device 3 via the transmission cable 4. The communication circuit 24 may supply the display device 3 with power from, for example, a battery via the transmission cable 4. The communication circuit 24 may receive ambient image signals transmitted from the display device 3 via the transmission cable 4. The ambient image signals may be signals indicating ambient image data corresponding to an ambient image captured by the camera 32. The video RAM 25 may store image data to be transmitted to the display device 3 as image signals. The video RAM 25 may store ambient image data in accordance with the ambient image signals received by the communication circuit 24. The image processing section 26 may read the image data from the flash ROM 22 and store the image data in the video RAM 25. The image processing section 26 may execute image processing to the image data stored in the video RAM 25 and generate image signals. The image processing section 26 may generate ambient image data from the received ambient image signals. The image processing section 26 may execute image processing of the ambient image data in response to an instruction from the CPU 20. The image processing section 26 may be provided to reduce the processing burden of the CPU 20 by executing various image processing.

The peripheral I/F 27 may be an interface at which predetermined components are electrically connected to each other. A power switch 271, a power indicator 272, a manipulation section 273 and the like may be connected to the peripheral I/F 27. The power switch 271 may be used to turn ON and OFF the power supply to the HMD 1. When the power switch 271 is turned ON, the HMD 1 may be started. For example, when the power switch 271 is turned ON, power may be supplied to the system box 2 from a battery (not shown). The power may be supplied also to the display device 3 from the system box 2 via the transmission cable 4. The power indicator 272 may indicate that the power supply is ON. The power indicator 272 may be turned on when the power switch 271 is turned ON. The manipulation section 273 may be an interface on which predetermined instructions to the system box 2 are input. The manipulation section 273 may comprise a plurality of operation buttons. The predetermined instructions may be input to the operation buttons of the manipulation section 273.

The display device 3 may comprise the image light generator 34, a CPU 38, a program ROM 39, a RAM 40, a communication circuit 41, an acceleration sensor 42 and a peripheral I/F 43. Each component of the display device 3 may be contained inside the housing 30. The CPU 38 may control various processes executed by the display device 3. For example, the CPU 38 may control the image light generator 34 to form image light Lim corresponding to image signals. The program ROM 39 may store computer programs for various processes to be executed in the display device 3. An example of processes executed in the display device 3 may be a process related to formation of the image light Lim by the image light generator 34. The RAM 40 may be a workspace used by the CPU 38 when executing the computer program stored in the program ROM 39.

The communication circuit 41 may control communication between the display device 3 and the system box 2. A transmission cable 4 may be electrically connected to the communication circuit 41. The transmission cable 4 may extend from the housing 30 to the rear side and be connected to the system box 2. The communication circuit 41 may transmit ambient image signals to the system box 2 via the transmission cable 4. The communication circuit 41 may receive image signals transmitted from the system box 2 via the transmission cable 4. The communication circuit 41 may receive power supplied from the system box 2 via the transmission cable 4. Power may be supplied also to each component of the display device 3 and to the camera 32. The acceleration sensor 42 may detect acceleration corresponding to the movement of the display device 3 accompanying the motion of the user's head. The acceleration sensor 42 may be a semiconductor sensor, such as an electrostatic capacitance sensor, a piezoresistance sensor, and a gas temperature distribution type sensor. The camera 32 may be provided on the upper surface of the display device 3. The movement of the display device 3 described above may be handled as the movement of the camera 32, and acceleration detected by the acceleration sensor 42 may be considered as acceleration corresponding to the movement of the camera 32. Acceleration detected by the acceleration sensor 42 may be transmitted from the communication circuit 41, via the transmission cable 4, to the system box 2 as acceleration signals, and received by the communication circuit 24. The acceleration signals may comprise information indicating the absolute value and the direction of acceleration. The peripheral I/F 43 may be an interface to which the camera 32 may be connected. The ambient image signals may indicate ambient image data corresponding to an ambient image captured by the camera 32. The ambient image signals may be transmitted to the system box 2 from the communication circuit 41 via the peripheral I/F 43.

The HMD 1 may be controlled by the CPU 20 of the system box 2 and by the CPU 38 of the display device 3. That is, when the CPU 20 executes computer programs stored in the program ROM 21, various functions may be implemented in the system box 2. The CPU 20 may be specified as a control section that executes various processes performed in the HMD 1. Similarly, various processes may be implemented in the display device 3 when the CPU 38 executes computer programs stored in the program ROM 39. The CPU 38 may be specified as a control section that executes various processes performed in the HMD 1. The computer programs may be stored in the program ROM 21 and in the program ROM 39 at the time of factory shipment of the HMD 1. Alternatively, the computer programs may be stored in a storage medium of a server outside the HMD 1. In a case in which the computer programs may be stored in a server, the computer programs may be downloaded from a storage medium of a server via an external connection circuit provided in the system box 2, and may be stored in the program ROM 21 and/or in the program ROM 39. The program ROM 39 may be an example of a storage device which may be read by a computer. Instead of the program ROM 39, a ROM, a HDD, a RAM and the like may be used as a storage device. The storage device in this case may be a non-transitory storage medium. A non-transitory storage medium may store data irrespective of the length of a time period for storing data. In this case, the computer programs may be transmitted to the HMD 1 from, for example, an external server as computer-readable transitory storage media (for example, transmission signals).

### Main Process

A main process executed by the HMD 1 will be described with reference to FIG. 4. The main process may be executed by the CPU 20 of the system box 2. The main process may be started when an operation and power supply are turned on when the power switch 271 is manipulated. The CPU 20 may execute a computer program for the main process stored in the program ROM 21 using the RAM 23. The computer program for the main process may comprise computer program modules for a registration process, a gesture reception process and a gesture determination process.

In S100, the CPU 20, which started the main process, may execute a HMD starting process. The HMD starting process may be a predetermined process executed when power supply is turned on. For example, power supply to the display device 3 may be started by the HMD starting process. In the image processing section 26, image processing of a portion corresponding to a predetermined page may be carried out among image data stored in the flash ROM 22. The image signals generated by the image processing may be transmitted to the display device 3 from the communication circuit 24. In the display device 3, the image light Lim may be generated by the image light generator 34 in accordance with the image signals received by the communication circuit 41 and an image corresponding to the image signals is displayed. The camera 32 may start capturing of the ambient image. With the capturing of the ambient image, ambient image signals may be transmitted to the system box 2 from the communication circuit 41 via the peripheral I/F 43. In the image processing section 26, ambient image data may be generated from the ambient image signals and sequentially stored in the video RAM 25. In S102, after the entire HMD 1 starts by the HMD starting process, the CPU 20 may execute the registration process. The registration process may be a process to register a first individual characteristic quantity indicating a characteristic for identifying a hand with which the user inputs an instruction, by gesture input, for a predetermined process executed by the HMD 1.

In S104, the CPU 20 may determine whether a gesture input mode is ON regarding input of the instruction for the predetermined process executed by the HMD 1. Information indicating ON or OFF of the gesture input mode may be stored in the program ROM 21 or the flash ROM 22 in association with, for example, the computer program for the main process. The CPU 20 determines S104 in accordance with the setting of the gesture input mode stored in the program ROM 21 or the flash ROM 22. For example, setting of the gesture input mode may be stored in the program ROM 21 in advance. Setting of the gesture input mode may be stored in the flash ROM 22 in accordance with the input received via the manipulation section 273. If the gesture input mode is off (S104: No), the CPU 20 determines whether a registration instruction has been input in accordance with the input received via the manipulation section 273 (S106). The registration instruction may be an instruction input when registering the first individual characteristic quantity as a user registration. In the present embodiment, since the registration process may be executed in S102 after the HMD starting process of S100, the registration instruction may be an instruction input when updating already registered first individual characteristic quantity. For example, the registration instruction may be input when the manipulation section 273 is manipulated. If a registration instruction has been input (S106: Yes), the CPU 20 may return the process to S102 and may execute the registration process. If no registration instruction has been input (S106: No), the CPU 20 may return the process to repeat S104.

If the gesture input mode is off (S104: No), the instruction to the HMD 1 may be input by manipulating the manipulation section 273. For example, if the image displayed on the display device 3 is updated to an image of the next page or to an image of a previous page, by manipulating an operation button included in the manipulation section 273 correlated with each process of a page feed process, page return process and the like, instructions for page feed and page return may be input.

If the gesture input mode is ON (S104: Yes), the CPU 20 may execute the gesture reception process (S108). The gesture reception process may be a process to receive input of an instruction in accordance with the gesture. The gesture may be a motion of a particular portion, such as a hand of the user. If the gesture input mode is ON (S104: Yes), the user who is using the HMD 1 may input an instruction for a predetermined process to be executed by the HMD 1 by moving the hand. For example, in the HMD 1, a motion of hand, such as moving the right hand from the right to the left, may be defined as an instruction to cause an image of the next page to be displayed. Therefore, the user may change the image displayed on the display device 3 to the image of the next page by moving the right hand from the right to the left. In addition, a motion of the hand of moving the right hand from the left to the right may be defined as an instruction with which the image of the previous page is displayed. Therefore, the user may change the image displayed on the display device 3 to the image of the previous page by moving the right hand from the left to the right. In the present embodiment, the user's right hand may be described as the hand for inputting instructions.

After S108 is executed, in S110, the CPU 20 may determine whether the user has manipulated the power switch 271 and the power supply has been turned off. If the power supply has not been turned off (S110: No), the CPU 20 may return the process to S104.

If the power supply has been turned off (S110: Yes), the CPU 20 may execute an HMD end process (S112) and terminates the main process. The HMD end process may be a predetermined process executed when the power supply is turned off. For example, transmission of the image signals and supply of power to the display device 3 may be stopped by the HMD end process.

### Registration Process

The registration process will be described with reference to FIG. 5. The registration process may be executed in 5102 of the main process illustrated in FIG. 4 and in S306 of the gesture reception process illustrated in FIG. 6. In S200, the CPU 20 which started the registration process may eliminate the first individual characteristic quantity registered in a predetermined storage area in the flash ROM 22. That is, CPU 20 may initialize a predetermined storage area in the flash ROM 22 which manages the first individual characteristic quantity in S200. In S202, the CPU 20 may perform control to capture an ambient image including the user's right hand. For example, the CPU 20 may display an image including two types of information displayed on the display device 3. One of the two types of information may be to notify that capturing an image of the right hand is started. The other of the two types of information may be to instruct the user to place the right hand in the direction along the line of sight in order to capture an ambient image including the right hand. The direction along the line of sight may be, for example, the direction in which the user's face may be oriented.

In the camera 32, capturing of the ambient image may have been started in the HMD starting process. Therefore, if the user moves the right hand to a capturing area of the camera 32, the ambient image including the user's right hand may be captured by the camera 32. The ambient image signals indicating the ambient image data corresponding to the ambient image captured by the camera 32 may be transmitted and received between the communication circuit 41 of the display device 3 and the communication circuit 24 of the system box 2 via the transmission cable 4. The ambient image signals may be converted into ambient image data by the image processing section 26 and the generated ambient image data may be stored in the video RAM 25. Then, the CPU 20 may specify the user's right hand from among the ambient image data stored in the video RAM 25. When the CPU 20 specifies the user's right hand, the CPU 20 may instruct the image processing section 26 to execute image processing to specify the user's right hand to the ambient image data. The image processing executed by the image processing section 26 may be based on already developed image processing technology. For example, color information indicating skin color of the hand and a template of an outline of the right hand may be stored in advance in the flash ROM 22. The template of an outline of the right hand may comprise information about nails and lines on the palms inside the outline in order to distinguish the right hand from the left hand. The image processing section 26 may detect a skin color area included in the ambient image data in accordance with the color information indicating skin color. The image processing section 26 may perform edge detection to the detected skin color area and detect an outline of the skin color area. Edge detection may be performed by, for example, a method using operators, an algorithm using a gradient of the primary differential, such as the canny edge detection method, and an algorithm using the zero crossing point of the quadratic differential to detect the local maximum of the gradient. The image processing section 26 may perform pattern matching of the outline of the detected skin color area and the template indicating the shape of the right hand. The CPU 20 may specify the user's right hand from the result of the image processing performed by the image processing section 26.

In S204, the CPU 20 may extract the first individual characteristic quantity indicating the characteristic for identifying the specified user's right hand. The characteristic quantity indicating the characteristic for identifying the right hand may be, for example, the shape of the right hand, the shape of finger(s), the shape of nail(s), color, the number of raised fingers, opening condition of the fingers, the size of the right hand, the ratio of lengths of the fingers, the size of the nails and/or the size of the fingers. In the present embodiment, at least one of a plurality of characteristic quantities may be extracted as the first individual characteristic quantity. The first individual characteristic quantity may be adopted from among the above described characteristic quantities in consideration of whether the hand which is used as a reference can be distinguished from other hands appropriately. For example, the characteristic quantity depending on the distance from the camera 32 may be adopted as the first individual characteristic quantity. The characteristic quantity depending on the distance from the camera 32 may be the characteristic quantity that varies when the distance between the camera 32 and the right hand is a first distance and when the distance is a second distance which is longer than the first distance. The right hand of the user using the HMD 1 may be located at a position closer to the camera 32 compared to other persons. For example, the size of the right hand or the size of each part of the right hand, such as the size of nails, may be captured as a larger image in the ambient image at the first distance than the second distance. In S206, the CPU 20 may register the extracted first individual characteristic quantity in a predetermined storage area in the flash ROM 22. The first individual characteristic quantity registered in S206 may be used as a reference in S312 of the gesture reception process. After S206 is executed, the CPU 20 may return the process to S104 of FIG. 4 or S300 of FIG. 6.

### Gesture Reception Process

The gesture reception process executed in S108 of the main process will be described with reference to FIG. 6. In S300, the CPU 20 may shift to a standby state in which the CPU 20 may receive an input of the instruction in accordance with a gesture. The user may move his/her own right hand to input the instruction. In the standby state, the image processing section 26 may generate the ambient image data from the ambient image signals sequentially received by the communication circuit 24 and store the generated data in the video RAM 25.

In S302, the CPU 20 may determine whether the instruction in accordance with the gesture has been input. The determination in S302 may be made in accordance with whether a predetermined gesture is included in the ambient image data stored in the video RAM 25. The predetermined gesture may be defined as an instruction for a predetermined process to be executed by the HMD 1 (i.e., a predetermined process is associated with gesture data). When a determination is made in S302, the CPU 20 may instruct the image processing section 26 to execute image processing for specifying a gesture with respect to the ambient image data. For example, the image processing section 26 may detect a skin color area included in the ambient image data in accordance with the color information indicating skin color. The color information may be stored in the flash ROM 22. The image processing section 26 may perform edge detection to the detected skin color area and may detect an outline of the skin color area. Edge detection may be performed by, for example, a method using operators, an algorithm using a gradient of the primary differential, such as the canny edge detection method, and an algorithm using the zero crossing point of the quadratic differential to detect the local maximum of the gradient. The image processing section 26 may perform pattern matching of the outline of the detected skin color area and a template indicating the shape of particular portion, such as the hand which performs the gesture. The image processing section 26 may specify the motion of the matched outline of the particular portion determined in the pattern matching (i.e., time transition of the position of the outline) as a gesture. The CPU 20 may specify the gesture from the result of the image processing performed by the image processing section 26. The target of the gesture to be specified from the result of the image processing may be the motion of either the left or the right hand. The image processing executed by the image processing section 26 may be based on known image processing technology. As described above, the defined gesture may be stored in the flash ROM 22 as gesture information. Specification of the gesture may be performed by, for example, comparing a gesture extracted by image processing by the image processing section 26 with a gesture indicated by the predetermined gesture information stored in advance in, for example, the flash ROM 22. The predetermined gesture information may be stored in the flash ROM 22 in association with a certain process.

At the same time with the specification of the gesture, the CPU 20 may specify the hand which is the target of the specified gesture from among the ambient image data stored in the video RAM 25. The CPU 20 may instruct the image processing section 26 to execute image processing for specifying a hand with respect to the ambient image data. The image processing executed by the image processing section 26 may be based on the same image processing technology as those of 5202 and 5204 of the registration process. The CPU 20 may specify the hand which is the target of the specified gesture from the result of the image processing by the image processing section 26. The CPU 20 may extract a second individual characteristic quantity indicating the characteristic for identifying the specified hand. The second individual characteristic quantity may be information similar to the first individual characteristic quantity. That is, if the first individual characteristic quantity is, for example, information indicating the shape and size of the user's right hand, the second individual characteristic quantity may be information indicating the shape and size of this hand extracted from the specified hand. The second individual characteristic quantity may be used in S312. The CPU 20 may store the extracted second individual characteristic quantity in, for example, the RAM 23.

If the gesture is not specified and, therefore, it is determined that no instruction in accordance with the gesture has been input (S302: No), the CPU 20 may determine whether a registration instruction has been input (S304). The user may manipulate, for example, the manipulation section 273 and input a registration instruction. If a registration instruction has been input (S304: Yes), the CPU 20 may execute the registration process described above (S306). If no registration instruction has been input (S304: No), or after S306 is executed, the CPU 20 may return the process to S300 and enter a standby state again.

If the gesture is specified and, therefore, it is determined that an instruction in accordance with the gesture has been input (S302: Yes), the CPU 20 may execute the gesture determination process (S308). The gesture determination process may determine whether the specified gesture is due to the movement of the camera 32 corresponding to the movement of the user's head. In S310, the CPU 20 may determine whether a gesture flag set in the gesture determination process is “1.” If the gesture flag is not “1” but “0” (S310: No), the CPU 20 may return the process to S300 and enter the standby state again.

If the gesture flag is “1” (S310: Yes), the CPU 20 may compare the first individual characteristic quantity and the second individual characteristic quantity to determine whether the first individual characteristic quantity and the second individual characteristic quantity correspond to (e.g., substantially coincide with) each other (S312). The CPU 20 may read the first individual characteristic quantity from the predetermined storage area of the flash ROM 22 to the RAM 23. The second individual characteristic quantity may be stored in the RAM 23. If the second individual characteristic quantity does not correspond to the first individual characteristic quantity, and if the second individual characteristic quantity is not included in a range determined in advance with respect to the first individual characteristic quantity, the CPU 20 may determine that the first individual characteristic quantity and the second individual characteristic quantity do not correspond to each other (S312: No). If the CPU 20 determines that the first individual characteristic quantity and the second individual characteristic quantity do not correspond to each other, the CPU 20 may return the process to S300 and enter the standby state again.

If the second individual characteristic quantity corresponds to the first individual characteristic quantity, or if the second individual characteristic quantity is included in a range determined in advance with respect to the first individual characteristic quantity, the CPU 20 may determine that the first individual characteristic quantity and the second individual characteristic quantity correspond to each other (S312: Yes). If the CPU 20 determines that the first individual characteristic quantity and the second individual characteristic quantity correspond to each other, in S314 the CPU 20 may control a process associated with the gesture specified in S302. For example, if the gesture specified in S302 is a motion of the user's right hand moving from the right to the left, the CPU 20 changes the image displayed on the display device 3 to an image of the next page. In accordance with the changing the image of the next page, in the image processing section 26, image processing of the next page portion of the image data may be carried out and image signals generated by the image processing is transmitted to the display device 3 from the communication circuit 24. In the display device 3, the image light Lim may be formed by the image light generator 34 in accordance with the image signals received by the communication circuit 41 and an image of the next page corresponding to the image signals is displayed.

After S314 is executed, in S316, the CPU 20 may determine whether an instruction to terminate the standby state has been input via, for example, the manipulation section 273. If no instruction has been input (S316: No), the CPU 20 may return the process to S300 and enter the standby state again. If an instruction has been input (S316: Yes), the CPU 20 may terminate the gesture reception process and return the process to S110 of FIG. 4. In a case in which the specified gesture has been an instruction corresponding to termination of the gesture reception process, the CPU 20 may affirm S316 (S316: Yes) and return the process to S110 of FIG. 4.

### Gesture Determination Process

The gesture determination process executed in S308 of the gesture reception process will be described with reference to FIG. 7. In S400, the CPU 20 may determine whether the absolute value of acceleration has exceeded a predetermined reference value. The absolute value of acceleration may be indicated by acceleration signals acquired from the acceleration sensor 42. The predetermined reference value may be set to a value at which it is considered that the user's head is not moving. For example, the predetermined reference value may be set to “0.” If the absolute value of acceleration is equal to or lower than the predetermined reference value (S400: No), the CPU 20 may proceed to S406. If the absolute value of acceleration is equal to or lower than the predetermined reference value, it may be determined that the user's head is not moving and the camera 32 provided on the upper surface of the housing 30 is not moving corresponding to the motion of the user's head, when it is determined that the gesture input is performed (S302 of FIG. 6: Yes).

If the absolute value of acceleration has exceeded the predetermined reference value (S400: Yes), the CPU 20 may determine whether the direction of the motion of the hand in the gesture specified by the gesture reception process of FIG. 6 is the direction opposite to the moving direction of the camera 32 (S402). The moving direction of the camera 32 may be specified by the direction of acceleration included in the acceleration signals. The direction of the motion of the hand may be specified when the gesture is specified. For example, the moving direction of the camera 32 specified by acceleration may be from the left to the right in the left-right direction. Then, the motion of the hand in the specified gesture may be from the right to the left in the left-right direction. In such a case, the CPU 20 may determine that these directions are opposite to each other (S402: Yes), and sets “0” as the gesture flag (S404). The gesture flag “0” may be information indicating that the gesture specified in the gesture reception process (S302: Yes) is based on relative motion accompanying the motion of the user's head.

Suppose, for example, that the moving direction of the camera 32 is from the right to the left in the left-right direction, or in the front-rear direction, or in the up-down direction. Suppose that the motion of the hand in the specified gesture is from the right to the left in the left-right direction. In such a case, the CPU 20 determines that these directions are not opposite to each other (S402: No) and proceeds the process to S406. The CPU 20 sets “1” as the gesture flag in S406. The gesture flag “1” is information indicating that the gesture specified by the gesture reception process (S302: Yes) has been the motion of the right hand which is previously defined and stored in the flash ROM 22 as the gesture information. After S404 or S406 is executed, the CPU 20 terminates the gesture determination process and returns the process to S310.

### Advantages of the Present Embodiment

According to the present embodiment, the following advantage may be obtained.

(1) If it is determined that the first individual characteristic quantity and the second individual characteristic quantity correspond to each other in S312 of the gesture determination process (S312: Yes), processes correlated with a gesture specified by the gesture determination process may be executed. It may be generally supposed that the user's head may move in a state in which the user is viewing an image displayed on the display device 3. For example, an instruction for changing the image displayed on the display device 3 into an image of the next page may have been defined as the motion of the hand, such as moving the right hand from the right to the left. In this case, the relative movement of the right hand and the camera 32 may also occur if the camera 32 is moved from the right to the left of the in the left-right direction of the user even if the user does not move the right hand. Then, as a premise of S312, in S400 and S402 of the gesture determination process, it may be determined whether the gesture specified by the gesture reception process is based on the fact that the camera 32 has performed a relative movement accompanying the motion of the user's head. Therefore, a process corresponding to the motion of the user's right hand, which is used as a reference of the input of the instruction, may be executed suitably while preventing malfunction accompanying a relative movement between the user's right hand and the camera 32. Therefore, unnecessary processes that may not be intended by the user may not be executed and thus operability of the HMD 1 becomes suitable.

(2) The main process may be started when the power supply is turned on. The HMD starting process may be executed in S100 and then the registration process may be executed in S102. Then, the first individual characteristic quantity indicating the characteristic for identifying the user's right hand may be registered in the predetermined storage area of the flash ROM 22. Since the first individual characteristic quantity has been registered, the first individual characteristic quantity which is used as a reference of the input of the instruction may be newly registered each time the HMD 1 is started. Further, at an arbitrary timing after the registration process is executed in S102 (S106: Yes, S306), the registration process may be executed. Therefore, the first individual characteristic quantity may be updated.

### Modification

The present embodiment may also be implemented by the following configurations. The same effects as those described above can be obtained by these configurations.

(1) Although the user's right hand has been described as an example, the hand for instructing the predetermined process to be executed by the HMD 1 may be the user's left hand or both the right and left hands. Further, in addition to the user's hand, for example, hands of other persons related to the user may be registered additionally. By additionally registering hands of other persons, it may be possible to input instructions to a single HMD 1 by a motion of any one of the registered hands.

(2) After the HMD starting process is executed in S100 of the main process, the registration process may be executed in S102. The registration process in S102 may be omitted. In S312 of the gesture reception process which is executed when S100 and S104 are sequentially executed and S104 is affirmed (S104: Yes), the first individual characteristic quantity which is not deleted in S200 and is registered in the predetermined storage area of the flash ROM 22 may be used as a reference. When updating the first individual characteristic quantity, the user may manipulate the manipulation section 273 and input a registration instruction (S302: No, S304: Yes)). When the registration instruction is input, the registration process may be executed (S306). Registration of the first individual characteristic quantity may be performed after executing the HMD starting process in S100 and execution of the registration process at subsequent arbitrary timing may be omitted. If the registration process at arbitrary timing is omitted, S106 of the main process may be omitted. If the decision in S104 is negative (S104: No), the CPU 20 may proceed to S110. If S304 and S306 of the gesture reception process are also omitted and if the decision in S302 is negative (S302: No), the CPU 20 may proceed to S300.

(3) In S106 of the main process, the registration instruction may be input via the manipulation section 273. The registration instruction in S106 may be input by motion of the user's hand. If the registration instruction is input by motion of the user's hand, the input of the registration instruction by motion of the hand may be received even when the gesture input mode is OFF (S104: No). The user may perform the gesture defined as the input of the registration instruction and input the registration instruction. The CPU 20 may specify the motion of the hand in the gesture which is input for the registration instruction in the same manner as in the case of the gesture reception process. Then, the processes of S308 to S312 may be executed and the registration process (S102) corresponding to the registration instruction may be executed.

(4) The HMD 1 may comprise the system box 2 and the display device 3 being separately provided. Predetermined components among the components of the system box 2 may be integrally contained in the housing 30 to integrally configure the HMD 1. For example, the flash ROM 22, the video RAM 25 and the image processing section 26 may be integrally contained in the housing 30. The camera 32, the power switch 271, the power indicator 272 and the manipulation section 273 may be connected to the peripheral I/F 43 of the display device 3. The manipulation section 273 may be manipulated when the user inputs predetermined instructions in the integrally configured HMD 1. The battery may also be built in the housing 30. If the battery is built in the housing 30, the communication circuit 41 may be omitted. If the battery is not built in, the communication circuit 41 may receive power supplied from an external battery via the transmission cable 4. The CPU 38 of the display device 3 may execute, using the RAM 40, the main process which the CPU 20 has executed. When executing the main process, the CPU 38 may execute the registration process, the gesture reception process and the gesture determination process which are executed at the time of execution of the main process. The program ROM 39 may store computer programs for the main process including the registration process, the gesture reception process and the gesture determination process.

Each process executed by the image processing section 26 may be executed by the CPU 20 or may be executed by the CPU 38 when the HMD 1 is an integrally configured HMD 1. The RAM 23 or a part of RAM 40 when the HMD 1 is an integrally configured HMD 1 may be allocated as a video RAM. If the RAM 23 or the RAM 40 is allocated as the video RAM, the image processing section 26 and the video RAM 25 may be omitted.

While the disclosure has been described in detail with reference to the specific embodiment thereof, this is merely an example, and various changes, arrangements and modifications may be applied therein without departing from the spirit and scope of the disclosure.

What is claimed is:

1. A wearable display control device comprising:
one or more processors; and
a memory storing computer-readable instructions therein, the computer-readable instructions, when executed by the one or more processors, causing the wearable display control device to perform processes comprising:
extracting a characteristic quantity from captured data including first captured data and second captured data obtained from a camera, the characteristic quantity indicating a characteristic of a particular part, the particular part being a reference for a gesture input;
storing a first characteristic quantity in first storage, the first characteristic quantity being the characteristic quantity extracted from the first captured data;
obtaining gesture data of the particular part from the second captured data, the second captured data being captured by the camera after the first characteristic quantity is stored in the first storage, the gesture data indicating a gesture of the particular part;
determining whether the first characteristic quantity stored in the first storage corresponds to a second characteristic quantity, the second characteristic quantity being extracted from the second captured data; and
controlling a specific process that controls a display device in response to determining that the first characteristic quantity corresponds to the second characteristic quantity and not controlling the specific process in response to determining that the first characteristic quantity does not correspond to the second characteristic quantity, the specific process being stored in second storage in association with the gesture data.

2. The wearable display control device according to claim 1, wherein the storing comprises storing the first characteristic quantity before starting to obtain the gesture data.

3. The wearable display control device according to claim 1, wherein the storing comprises storing the first characteristic quantity after starting to obtain the gesture data and when an instruction to store the first characteristic quantity is received by the wearable display control device.

4. The wearable display control device according to claim 1, further comprises:
an attaching portion configured to be mountable on a head of a user and to detachably support the display device; and
the camera provided in at least one of the display device and the attaching portion.

5. The wearable display control device according to claim 4, further comprises:
an acceleration sensor provided in the display device and configured to detect acceleration corresponding to movement of the display device and generate an acceleration signal based on the detected acceleration,
wherein the computer-readable instructions, when executed by the one or more processors, instruct the one or more processors to perform processes further comprising:
determining whether a moving direction of the particular part indicated by the gesture data is opposite to a moving direction of the camera specified by the acceleration signal,
wherein the controlling further comprises not controlling the specific process in response to determining that the moving direction of the particular part is opposite to the moving direction of the camera.

6. The wearable display control device according to claim 4, wherein controlling the specific process comprises controlling the display device to change a displayed image from one image to another image.

7. The wearable display control device according to claim 4, wherein the first characteristic quantity and the second characteristic quantity vary according a distance between the camera and the particular part.

8. The wearable display control device according to claim 1, wherein the particular part is a hand of a user.

9. A non-transitory computer-readable medium storing computer readable instructions, the instructions, when executed by a processor of a wearable display control device, perform processes comprising:
extracting a characteristic quantity from captured data including first captured data and second captured data obtained from a camera of the wearable display control device, the characteristic quantity indicating a characteristic of a particular part, the particular part being a reference for a gesture input;
storing a first characteristic quantity in first storage, the first characteristic quantity being the characteristic quantity extracted from the first captured data;
obtaining gesture data of the particular part from the second captured data, the second captured data being captured by the camera after the first characteristic quantity is stored in the first storage, the gesture data indicating a gesture of the particular part;
determining whether the first characteristic quantity stored in the first storage corresponds to a second characteristic quantity, the second characteristic quantity being extracted from the second captured data; and
controlling a specific process that controls a display device in response to determining that the first characteristic quantity corresponds to the second characteristic quantity and not controlling the specific process in response to determining that the first characteristic quantity does not correspond to the second characteristic quantity, the specific process being stored in second storage in association with the gesture data.

10. The non-transitory computer-readable medium according to claim 9, wherein storing comprises storing the first characteristic quantity before starting to obtain the gesture data.

11. The non-transitory computer-readable medium according to claim 9, wherein the storing comprises storing the first characteristic quantity after starting to obtain the gesture data and when an instruction to store the first characteristic quantity is received by the wearable display control device.

12. The non-transitory computer-readable medium according to claim 9, further comprises:
determining whether a moving direction of the particular part indicated by the gesture data is opposite to a moving direction of a camera of the wearable display control device, the moving direction being specified by an acceleration signal received from an acceleration sensor of the wearable display control device,
wherein the controlling comprises not controlling the specific process in response to determining that the moving direction of the particular part is opposite to the moving direction of the camera.

13. The non-transitory computer-readable medium according to claim 9, wherein controlling the specific process comprises controlling the display device to change a displayed image from one image to another image.

14. The non-transitory computer-readable medium according to claim 9, wherein the first characteristic quantity and the second characteristic quantity vary according a distance between the camera and the particular part.

15. A method comprising:
extracting a characteristic quantity from captured data obtained from a camera of a wearable display control device, the characteristic quantity indicating a characteristic of a particular part, the particular part being a reference for a gesture input;
obtaining gesture data of the particular part from the captured data, the gesture data indicating a gesture of the particular part;
determining whether a first characteristic quantity stored in a first memory corresponds to a second characteristic quantity, the second characteristic quantity being extracted from the captured data; and
controlling a specific process that controls a display device in response to determining that the first characteristic quantity corresponds to the second characteristic quantity and not controlling the specific process in response to determining that the first characteristic quantity does not correspond to the second characteristic quantity, the specific process being stored in a second memory in association with the gesture data.

16. The method according to claim 15 further comprises:
storing the first characteristic quantity in the first memory, the first characteristic quantity being the characteristic quantity extracted from another captured data before starting to obtain the gesture data.

17. The method according to claim 16, wherein storing further comprises storing the first characteristic quantity in the first memory after starting to obtain the gesture data and when an instruction to store the first characteristic quantity is received by the wearable display control device.

18. The method according to claim 15, further comprises:
determining whether a moving direction of the particular part indicated by the gesture data is opposite to a moving direction of a camera of the wearable display control device, the moving direction being specified by an acceleration signal received from an acceleration sensor of the wearable display control device,
wherein the controlling comprises not controlling the specific process in response to determining that the moving direction of the particular part is opposite to the moving direction of the camera.

19. The method according to claim 15, wherein controlling the specific process comprises controlling the display device to change a displayed image from one image to another image.

20. The method according to claim 15, wherein the first characteristic quantity and the second characteristic quantity vary according a distance between the camera and the particular part.
